(19) United States
(12) Patent Application Publication
(10) Pub. No.: US 2009/0288138 A1
(43) Pub. Date: Nov. 19, 2009

(54) Methods, systems, and apparatus for peer-to peer authentication

(76) Inventor: Dimitris Kalofonos, Cambridge, MA (US)

Correspondence Address: Hollingsworth & Funk, 8500 Normandale Lake Blvd., Suite 320, Minneapolis, MN, 55437, US

(21) Appl. No.: 12/152,921

(22) Filed: May 19, 2008

(51) Int. Cl. H04L 9/32

(52) U.S. Cl. 726/2

(57) ABSTRACT

Peer-to-peer authentication involves generating an authenticatable, globally unique, peer-to-peer identifier to associate a device with a user identity. The user identity is associated with one or more peer devices of a user. The peer-to-peer identifier, together with authentication credentials of a legacy Internet service, is sent to an infrastructure authentication service. The legacy Internet service is capable of verifying the user identity based on the authentication credentials. Based on verification of the authentication credentials, a list of authenticatable, globally unique, peer-to-peer identifiers that bind the peer devices to the user identity is received from the infrastructure authentication service. A peer-to-peer identifier that binds the selected peer device to the user identity is received from a selected one of the peer devices, and the selected peer device authenticated as associated with the user identity based on receiving the respective peer-to-peer identifier.

### FIELD OF THE INVENTION

This invention relates in general to computer networks, and more particularly to authentication in peer-to-peer networks.

### BACKGROUND OF THE INVENTION

Centralized, Web-based, Internet consumer services (e.g. OVI™, iTunes™, Flickr™, Myspace™, Facebook™, Amazon™) are increasingly gaining in popularity and market share. These services may provide access to, among other things, online music, video rentals, photo printing, gaming, shopping, and social networking. The current paradigm common to these services is that of centralized Web-based user interaction. According to this paradigm, a user typically registers for a service (either for free or for a monthly fee) and then he/she gains access to the service provider's infrastructure over the Web, which stores or offers for download/streaming all related content and services necessary to the users.

In contrast to the infrastructure-based services, new Peer-to-Peer (P2P) technologies are emerging, which offer an alternative P2P paradigm of personal and social networking services. P2P systems can allow real-time access and sharing of content and personal services hosted directly on users' own personal devices (e.g., mobile phones, PDAs, PCs, portable music players, DVRs, media servers, game consoles, Wi-Fi cameras, etc.), without requiring users to first register and upload to a multitude of different services and web-sites. The result is an immediate, real-time, and personal user experience.

Pure P2P services, however, do have some shortcomings. Such services may be run only on end-users' own personal devices, and thus do not require infrastructure support. As such, full-time connectivity and full-time availability of content and services may not be possible in many P2P implementations. Furthermore, allowing access and sharing only of resources hosted on users' own devices, without integrating with value-adding Internet services, can restrict consumers and limit their choices.

Because of the unique advantages but also shortcomings of both the pure web-based and P2P paradigms for personal and social consumer services, a hybrid system that combines a web-based infrastructure with a P2P component can offer a much more powerful user experience and a competitive advantage in the marketplace. An example of such a hybrid P2P/Infrastructure system is described in U.S. patent application Ser. No. 12/072,937, filed on Feb. 29, 2008. In that disclosure, a system is described for integrating infrastructure Internet consumer services with a P2P component, referred to as “MyNet.”

One commonly implemented feature Web-based Internet consumer services is that of establishing a users' online identity. This online identity, most commonly derived from a username and password established by the user at registration time, is used for identification, authentication, and access control when accessing the various aspects of the services provided by the service provider. Because the users' online identities are authenticatable and securely stored in infrastructure controlled by the service provider, they can be used in sensitive transactions, such as online payments and access to restricted services.

Online P2P identities with similar properties as infrastructure identities are generally not available in pure P2P systems. Examples of infrastructureless P2P identities include identities selected by the users themselves which cannot be authenticated, identities derived by network or P2P protocols, or simply no identities at all (P2P anonymity). The limitations inherent in these loosely authenticated identities limits the types of commercial transactions that can take place over pure P2P systems. Furthermore, this limits the application of access control in pure P2P systems, which are most commonly used for services that have no access restrictions (open to the entire P2P community).

P2P systems that need strong online identities, such as Skype™, simply introduce online identity servers as a centralized component. However, this prevents the P2P interactions when access to the online identity server is not possible. The identity server may not be accessible, for example, when only local IP connectivity is possible. Only local IP connectivity may be available over proximity connections (e.g. with Bluetooth), over ad-hoc networks (e.g. 802.11 ad-hoc), and/or when the online identity server is down.

It is desirable for hybrid P2P/Infrastructure Internet consumer services to offer identities that are secure, dependable and authenticatable and at the same time can be reliably used in P2P interactions without the need to access every time a centralized online identity server. This disclosure addresses these and other needs.

### SUMMARY OF THE INVENTION

To overcome limitations in the prior art described above, and to overcome other limitations that will become apparent upon reading and understanding the present specification, the present invention discloses a system, apparatus and method for maintaining identities in peer-to-peer networking systems. In one embodiment, a method involves generating an authenticatable, globally unique, peer-to-peer identifier to associate a device with a user identity. The user identity is associated with one or more peer devices of a user. The method further involves sending the peer-to-peer identifier together with authentication credentials of a legacy Internet service to an infrastructure authentication service. The legacy Internet service is capable of verifying the user identity based on the authentication credentials. Based on verification of the authentication credentials, a list of authenticatable, globally unique, peer-to-peer identifiers that bind the peer devices to the user identity is received from the infrastructure authentication service. The respective peer-to-peer identifier that binds a selected one of the peer devices to the user identity is received from the selected peer device. The selected peer device is authenticated as being associated with the user identity based on receiving the respective peer-to-peer identifier.

In more particular embodiments, the method further involves communicating the peer-to-peer identifier of the device to the peer devices to authenticate the device as associated with the user identity. In such a case, the peer-to-peer identity of the device is bound to the user identity via the infrastructure authentication service. In different scenario, the method further involves locally caching the list of peer-to-peer identifiers that bind the peer devices to the user identity, and referencing the local cache when authenticating the selected peer device as associated with the user identity. In such a case, the method may also involve repeatedly comparing the local cache to a database of the infrastructure authentication service to determine a change in the list of peer-to-peer identifiers that bind the peer devices to the user identity.

In more particular embodiments, the method further involves determining a different user identity associated with the legacy Internet service. A request to authenticate other devices of the different user a) to the device and b) to the peer devices of the user is sent to the infrastructure authentication service. A second list of authenticatable, globally unique, peer-to-peer identifiers that bind the other peer devices to the different user identity is received from the infrastructure authentication service. The other peer devices are authenticated as associated with the different user identity based on communication from the other peer devices of the respective peer-to-peer identifiers that bind the other peer devices to the different user identity. In such a case, sending the request to authenticate other devices of the different user may further involve sending the authentication credentials of the user identity to verify the user identity before fulfilling the request.

In another variation of the method, the method further involves regulating the selected peer device's access to resources of the device with permissions of the user based on authenticating the selected peer device.

In another embodiment of the invention, a method involves receiving from a device an authenticatable, globally unique, peer-to-peer identifier used to associate the device with a user identity. The user identity may be used to share resources among one or more peer devices of a user. Also received from the device are authentication credentials associated with a legacy Internet service that maintains the user identity. The authentication credentials are verified with the legacy Internet service. Based on verification of the authentication credentials, a) a list of authenticatable, globally unique, peer-to-peer identifiers that bind the peer devices to the user identity for authenticating the peer devices are sent to the device; and b) the peer-to-peer identifier of the device that binds the device to the user identity for authenticating the device is sent to the peer devices.

In more particular embodiments, the method further involves repeatedly providing updates to the device in response to changes in the list of peer-to-peer identifiers that bind the peer devices to the user identity. In other more particular embodiments, the method further involves receiving from the device a request to authenticate other peer devices of a different user to a different user identity. The different user identity is associated with the legacy Internet service. In such a case, a second list of authenticatable, globally unique, peer-to-peer identifiers that bind the other peer devices to the different user identity is determined, and the second list of peer-to-peer identifiers is sent to the device. The device uses the second list of peer-to-peer identifiers to authenticate the other peer devices as associated with the different user. Further in such a case, receiving the request to authenticate the other peer devices may further involve a) receiving from the device the authentication credentials associated with the legacy Internet service that maintains the user identity; and b) verifying the authentication credentials with the legacy Internet services before fulfilling the request.

In another embodiment of the invention, an apparatus includes a network interface capable of Internet communications with an infrastructure authentication service and one more peer devices of a user. A processor is coupled to the network interface, and memory is coupled to the processor. The memory includes instructions that cause the processor to: a) generate an authenticatable, globally unique, peer-to-peer identifier to associate the apparatus with a user identity (the user identity is associated with the one or more peer devices); b) send the peer-to-peer identifier together with authentication credentials of a legacy Internet service to an infrastructure authentication service (the legacy Internet service is capable of verifying the user identity based on the authentication credentials); c) based on verification of the authentication credentials, receive from the infrastructure authentication service a list of authenticatable, globally unique, peer-to-peer identifiers that bind the peer devices to the user identity; d) receive, from a selected one of the peer devices, the respective peer-to-peer identifier that binds the selected peer device to the user identity; and e) authenticate the selected peer device as associated with the user identity based on receiving the respective peer-to-peer identifier.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWING

The invention is described in connection with the embodiments illustrated in the following diagrams. In the drawing and disclosure, the same reference numbers may be used in multiple figures to indicate the same/similar components.

FIG. 1 is a block diagram illustrating system features according to embodiments of the invention;

FIG. 2 is a block diagram illustrating adding a new device added to a personal device cluster according to an embodiment of the invention;

FIG. 3 is a block diagram illustrating removing a device from a personal device cluster according to an embodiment of the invention;

FIG. 4 is a block diagram illustrating providing access to a personal device cluster for a personal contact according to an embodiment of the invention;

FIG. 5 is a block diagram illustrating updating between different users' personal device clusters adding a new device according to an embodiment of the invention;

FIG. 6 is a block diagram illustrating authenticating access to a personal device cluster according to an embodiment of the invention

FIG. 7 is block diagram of a mobile computing arrangement according to an embodiment of the invention;

FIG. 8 is block diagram of an infrastructure authentication service computing arrangement according to an embodiment of the invention; and

FIGS. 9-10 are flowcharts describing procedures according to embodiments of the invention.

### DETAILED DESCRIPTION OF EMBODIMENTS OF THE INVENTION

In the following description of various embodiments, reference is made to the accompanying drawings that form a part hereof, and in which is shown by way of illustration various embodiments in which the invention may be practiced. The individual drawings may use the same reference numbers to refer to the same or similar features where such features are common to different embodiments. It is to be understood that other embodiments may be utilized, as structural and operational changes may be made without departing from the scope of the present invention.

Generally, the present disclosure is related to systems, apparatus, and methods for integrating an existing username/password-based centralized identity system with a P2P distributed identity system based on self-signed certificates. This dual identity system allows users to use their centralized identities when interacting with each other in a P2P manner. These identities can be used for P2P transactions without having to share centrally maintained credentials, and further without requiring contemporaneous access to (or modifications of) any centralized servers during P2P interactions. The integration may be realized via two proposed components: (a) the P2P Identity Middleware Module (PIMM), which is implemented as part of the P2P middleware on personal devices; and (b) the P2P Identity Management Server (PIMS), which is an add-on part of the service provider infrastructure.

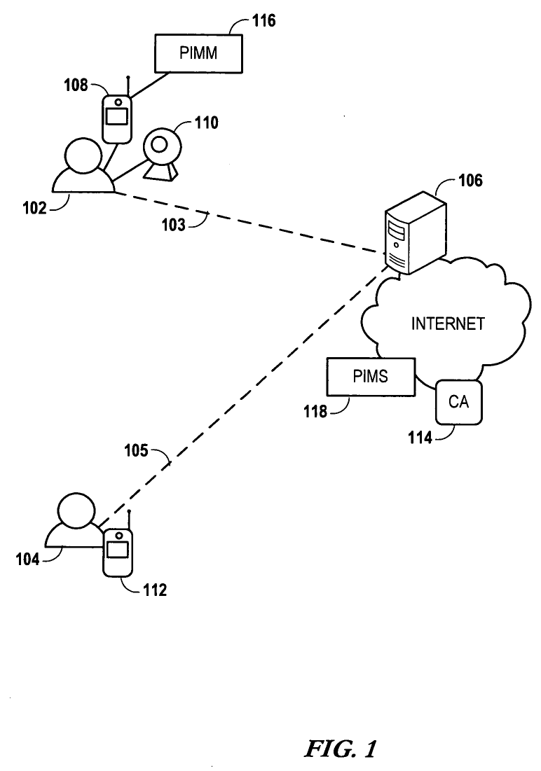

A concrete example is presented in FIG. 1, which is a block diagram that illustrates how such a system might operate according to an embodiment of the invention. Two users, Kimmo 102 and Dimitris 104 have accounts with an online service 106 (represented by dashed lines 103, 105) with respective username/password combinations of “kimmo/kpass” and “dimitris/dpass.” Kimmo 102 decides to share with user “dimitris” (e.g., the identity user 104 has established with service 106) a personal video that is located in Kimmo's phone 108 as well as access to Kimmo's Wi-Fi camera 110 at home. In this scenario, one problem is how Dimitris' phone 112 can prove to Kimmo's phone 108 or Wi-Fi camera 110 that the person accessing is really user “dimitris”? It may be assumed that Kimmo's phone 108 does not know Dimitris' password (dpass) (and vice versa) and therefore cannot use it to authenticate Dimitris' phone 112.

One way to share the video using the existing username/password identities registered with the service 106 would be for the users 102, 104 to first upload the shared data to respective accounts on the service 106, and then allow access via the service 106 to other users of the service 106. In this example, Kimmo 102 would upload video from the phone 108 to the service 106, and then allow user “dimitris” to access it. Dimitris 104 would then login, and after authenticating with the service 106 using the correct username/password, would be able to access what Kimmo 102 had uploaded. This approach is not a P2P interaction. For example, access to the content would not be possible device 112 only had local IP connectivity with devices 108, 110 via ad-hoc WLAN or Bluetooth, but not with service 106. In addition, centralized access in this way may not be possible for services that are not files (e.g., streaming video from Wi-Fi camera 110).

Another option would be to obtain from a Certification Authority (CA) 114 certificates that would allow users 102, 104 to prove that they are users “dimitris” and “kimmo” registered with service 106. Then Dimitris' phone 112 could use its certificate to prove to Kimmo's devices 108, 110 that this is indeed user “dimitris” trying to access what Dimitris 104 has been authorized to view. However, this alternative requires that the CA 114 issue and manage (e.g., through revocation lists, etc.) certificates to all personal devices, which may burdensome and costly for users 102, 104 and/or service provider 106, and may require changes to the service infrastructure.

On the other hand, if users 102, 104 were to use only their P2P identities, the above P2P scenario would work, but user 102 would not be able to share with user “dimitris” registered with service 106. Instead the users 102, 104 would have to establish separate P2P user identities (e.g. with user “P2Pdimitris”). This may force Kimmo 102 to share content with Dimitri 104 differently when it is hosted on the service 106 (where it is shared with user “dimitris”) than when the content is hosted on Kimmo's personal devices 108, 110 (you would share it with user “P2Pdimitris”). This could be confusing because it may require maintaining two contact lists, having different views on who has access to what, having different GUI to access, and share content, having to remember additional usernames/passwords, etc. Further, such a solution does not provide the service 106 the opportunity to be a value-added “control point” to control the user's P2P identities. If the users 102, 104 have to rely on separate identities for P2P sharing and decide to leave service 106, they can both go to an alternate service, and can still maintain their P2P identities for sharing. The provider of service 106 would like to increase incentives to remain with the service 106, so allowing users to leverage their online identity in the P2P context may benefit both users 102, 104 and service providers 106.

A pure P2P user identity system (part of proposed “MyNet” framework) was described in U.S. patent application Ser. No. 12/072,937, entitled “Methods, Systems, And Apparatus For Using Virtual Devices With Peer-To-Peer Groups,” filed on Feb. 29, 2008. That reference described, among other things, a P2P user identity system where users' devices could authenticate to each other using self-signed certificates. In that system, no central identity management was assumed, therefore all devices were equally responsible of propagating the information about when a new device is added to or removed from a user's Personal Device Cluster (PDC). One problem with pure P2P identity systems is that unauthorized users can add or remove devices to a PDC (e.g. via unattended or lost devices) thus modifying the P2P identity, since there is no authoritative entity where the user identity is anchored.

In the illustrated embodiment of FIG. 1, the system integrates the P2P and centralized user identities and creates a dual identity for all interactions. The system also “anchors” the P2P identity on a centralized identity system, thus making it more difficult for unauthorized users to modify the P2P identity. The system complements an existing centralized, Web-based Internet consumer identity system associated with a legacy service 106, such as the Nokia™ Consumer Identity Management—NCIM framework for the Nokia™ OVI Web portal. The service 106 is augmented with a P2P, decentralized component that can be used for P2P interactions, without requiring access to an identity server. The end result is that the user 102 will have a dual system identity: a master central identity with the service 106 (e.g., OVI identity) and a secondary implicit P2P identity, which will be used for P2P interactions (e.g., a MyNet identity).

Each user may already have established a Web-based account and identity (user profile, centralized username/password credentials) with the Internet service provider 106. He/she can use this identity to login on the Web and use the services offered by the service provider 106. It may also be possible that the service provider 106 offers P2P middleware (e.g., its own or that of 3rd party after an agreement), through which its users can also interact with each other in a P2P fashion (e.g., sharing personal content, chatting, VoIP, or any other P2P social networking applications), in addition to accessing its centralized service offerings. An example of such a hybrid P2P/Infrastructure system is OVI extended with the MyNet P2P middleware.

The illustrated system uses two basic components: a) a P2P Identity Middleware Module (PIMM) (e.g., PIMM 116 on device 108) that runs on all personal devices that the users use for P2P interactions; and b) a P2P Identity Management Server (PIMS) 118 that interacts with the service provider's infrastructure and complements existing functionality of centralized identity management. The system is designed to interact with the existing centralized identity management infrastructure without requiring any infrastructure changes. The proposed system is complementary to existing identity management infrastructure and integrates with it seamlessly as explained below.

The proposed system leverages the advantages of infrastructure and P2P paradigms by using a dual P2P/Web Identity (P2P-ID/WEB-ID). A device (or each user in a device with multi-user support) is identified in all P2P interactions by a Unique P2P Identifier (UPID), generated by hashing a self-signed certificate (e.g., hashing a self-signed X.509 certificate to a 128-bit UPID) at users' personal devices. The UPID may be considered globally unique, meaning that the probability of the same UPID being generated twice is very small in the given context.

Because UP IDs are derived from standard public key based (PK) certificates, they are authenticatable using standard PK cryptography methods. The UPIDs are the basis of P2P authentication and access control. The user's P2P identity (P2P-ID) is the set of authenticatable UPIDs corresponding to a user (e.g., a UPID for each of the personal devices belonging to the user), as in some pure P2P systems. However, unlike pure P2P systems, the PIMM 116 running on a personal device 108 cooperates with the PIMS 118 in the infrastructure to maintain a mapping of the registered user's online identity (WEB-ID) to his/her P2P-ID (e.g., to the set of UPIDs corresponding to the user). This mapping information is maintained by the PIMS 118 based on information and updates sent by the PIMM 116 running on users' personal device 108.

The PIMS 118 is the authoritative maintainer of the WEB-ID to P2P-ID mappings. The user's personal device 108 maintains local caches of the WEB-ID to P2P-ID mappings for their owner 102 and other users in his/her social neighborhood (e.g., other users 104 or “buddies” in his/her contact list), by synchronizing with the PIMS 118. This synchronization may be triggered by specific events (e.g., a device gets connected to a “home” network, a new “buddy” is added in the contact list, a new device is purchased) and/or periodically (e.g., every night, every week). Because UPIDs are fairly small (e.g., 128-bits, or 16 bytes) and change relatively infrequently (e.g. when the user or one of his contacts purchases or loses a device, when a new “buddy” is added in the contact list), the total data exchanged for synchronization is small even for large personal networks. For example, a user with 300 contacts, each with 10 personal devices may require about 48 Kbytes to be transmitted the first time a device synchronizes and a few tens of bytes on each update thereafter.

The user's WEB-ID is used for authentication and access control when accessing the service providers Web-based services 106 (e.g., buying music). The user's P2P-ID is used when the user 102 access and shares his/her personal resources in a P2P manner (e.g. when user 102 shares a music playlists with some other user in a contact list). The dual user identity is created and maintained by a mapping between a user's WEB-ID and P2P-ID. Even so, these two identities are used independently, allowing for maximum flexibility and seamless integration with existing systems.

The PIMM 116 is part of the P2P middleware running on users' personal devices. In regular operation, the PIMM 116 authenticates that a P2P request coming from a device with a certain UPID belongs to a user with a certain WEB-ID. This is the basis for P2P access control. The PIMM 116 may also locally manage UPID credentials. For example, the PIMM 116 may generate and hash self-signed certificates (e.g., X.509 certificates) to create a UPID for the device 108 or current user 102. This happens, for example, when the user 102 first operates a new device or installs the P2P middleware on an existing device.

The PIMM 116 registers a new UPID in the internal database of the PIMS 118 in response to generation of the certificate. If the user 102 already has a WEB-ID with the service 106, this registration involves adding the new PUID to the set of this user's PUIDs that are mapped to the user's WEB-ID. This is a protected operation, and the user may need to successfully authenticate using his/her WEB-ID credentials in order for the operation to complete.

The PIMM 116 may periodically synchronize the locally cached mapping of WEB-IDs to P2P-IDs (and that of other users in his/her contact list), with the corresponding mappings maintained by the PIMS 118. Because the events that might require updating these mappings are relatively infrequent, and the amount of data is relatively small, such synchronization can be performed in the background with little effect on device performance.

The PIMM 116 may also need to remove a UPID from the internal database of the PIMS 118 under some conditions. For example the UPID may be manually removed when a user loses or sells one of his/her devices. This removes the PUID from the set of this user's PUIDs that are mapped to his WEB-ID. This is a protected operation and the user may need to successfully authenticate using his WEB-ID credentials in order for the operation to complete.

The PIMS 118 may be a separate server in the service provider's infrastructure. The PIMS 118 maintains, for each registered user, the mapping between the user's WEB-ID and his/her P2P-ID (i.e. the set of UPIDs corresponding to the user). The PIMS 118 receives requests from PIMM 116 to update (e.g., add/delete) the set of UPIDs mapped to the WEB-IDs. These updates are protected operations that take place over secure connections (e.g., using Secure Sockets Layer, SSL) between the PIMS and the PIMM running on users' personal devices. In order for these connections to be established and the requests to be accepted, the PIMS 118 may require the user to authenticate using his WEB-ID credentials.

The PIMS 118 may be capable of performing WEB-ID user authentication. In order not to require any changes to existing implementation of the centralized identity management system, the PIMS 118 authenticates the WEB-ID of the user by implementing a user authentication proxy, which is the component that is actually authenticated by the legacy centralized identity server. For example, when registered user 102 is asked by the PIMS 118 to authenticate using his/her username and password for service 106, the PIMS user authentication proxy is using the provided username and password in order to authenticate itself with the identity management subsystem of service 106. If the user authentication proxy is successful, then the PIMS 118 also considers that the user 102 is successfully authenticated. As a result a secure connection can be established between the user device 108 and the PIMS 118, and protected operations can take place.

The PIMS 118 is the authoritative owner of the mapping information between WEB-IDs and P2P-IDs. The PIMS 118 maintains the master copy of this information, while the users' personal devices are allowed to synchronize this information in their local caches. When the PIMS 118 receives a synchronization request from a device with a certain UPID, after authenticating this UPID using standard PK mechanisms, it proceeds to synchronize its information with this device only if the device's UPID has already been registered in its internal database by the user.

One feature of the disclosed embodiments of the invention is that P2P interaction does not require concurrent or contemporaneous access to the centralized identity management system or to the PIMS 118. The users' devices 108, 110, 112 are able to authenticate each other and control access to their resources based on the locally cached information of UPIDs. For example, assume that user 102 has user 104 in his contact list. At some point user 102 decides to give user 104 access to his Wi-Fi camera 110 at home. To do this, the user 102 adds (e.g., via PIMM 118) the identity of user 104 associated with service 106 to the PIMS 118. In response, the PIMS 118 updates a local PIMM cache (not shown) of the camera 110 with all of the UPIDs of devices associated with user 104, including device 112.

When user 104 uses devices 112 to access Wi-Fi camera 110, the camera 110 authenticates device 112 using the self-signed X.509 certificate provided with the UPID of device 112. The camera 110 then looks in its locally cached WEB-ID to P2P-ID cache to see if the UPID provided by device 112 corresponds to user 104. If yes, then access to device with UPID is allowed.

Note that in this P2P interaction there is no need to authenticate the WEB-ID of username of user 104. In this way, there is no need for users' personal devices to locally store private security information (e.g. Web service passwords) necessary to authenticate the WEB-ID. As a result, this information is not compromised when the user loses a device or when a device is replaced.

Because the disclosed embodiments do not require any changes to existing infrastructure or P2P protocols, the proposed dual P2P/WEB identity can be applied to any hybrid personal and social networking Internet services platform that combines a Web-based infrastructure and a P2P component. An example of such a hybrid P2P/Infrastructure system is OVI extended with the MyNet P2P middleware. In such an implementation, OVI users would maintain all OVI functionality and OVI identity as it is today, but they could extend their identity in P2P interactions for access and sharing over the MyNet P2P overlay. Their MyNet identity (i.e. their P2P-ID) will be anchored and integrated with their OVI identity, but access to OVI authentication servers will not be required for P2P interactions. Furthermore, optionally, the proposed invention may allow OVI users to interact in a P2P manner with other non-OVI users who decide to install the MyNet P2P middleware. This may provide an incentive for non-OVI users to signup for OVI themselves.

The illustrated embodiments of the invention have the advantage that they complement an online user identity with a P2P decentralized user identity in a seamless manner, without requiring any changes in the centralized identity management systems. Because the P2P identity of users is anchored on their online identity, the advantages of a centralized identity can be retained, both for online transaction over the Web or P2P interactions among users over the P2P overlay network.

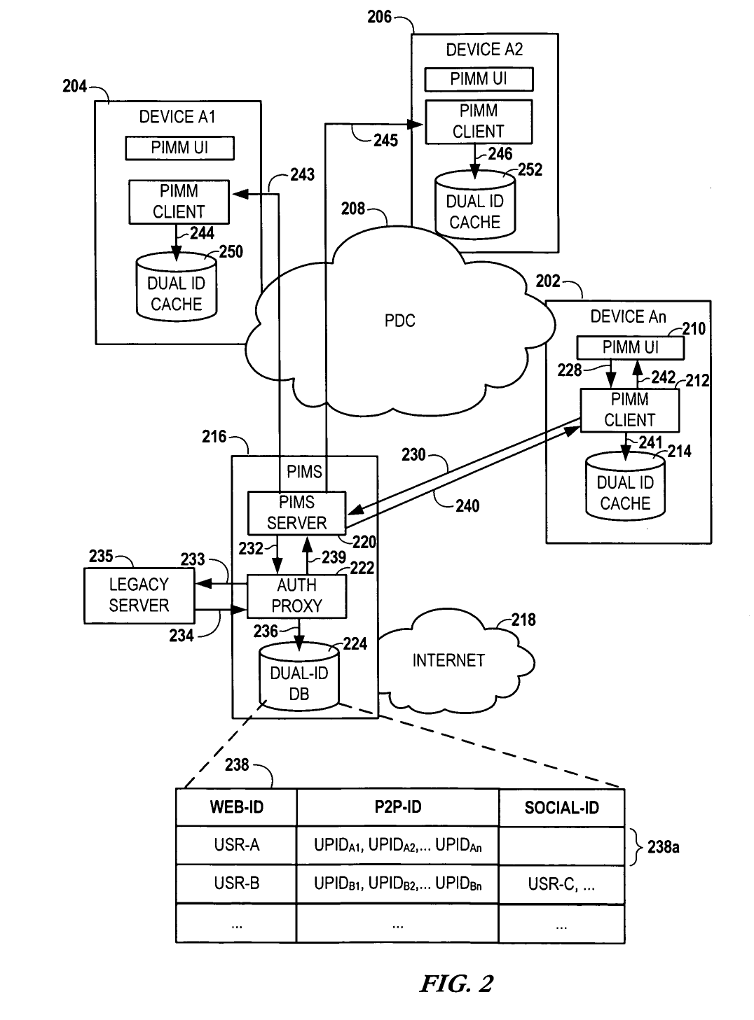

In reference now to FIG. 2, block diagram shows more details of a P2P identity framework interactions according to an embodiment of the invention. In the illustrated framework, personal content and services are exposed by distributed applications running on user's devices, here shown as generic devices 202, 204, 206. The devices 202, 204, 206, when properly configured, may all appear to be connected and running over the same secure virtual personal network. This secure personal network is referred to herein as a Personal Device Cluster (PDC) 208. The PDC 208 is formed by connecting users' personal devices (e.g., mobile phones, PDA, music players, game consoles, PCs, DVRs), and allowing pervasive access and sharing of content and services contained therein.

Each device includes a PIMM User Interface (UI), PIMM client, and dual identity cache (e.g., PIMM UI 210, PIMM client 212, and cache 214 shown in device 202). These PIMM components 210, 212, 214 are components of the PIMM client-side, middleware, authentication module described above. The client-side PIMM components interact with a PIMS service 216 that is reachable on a publicly addressable network such as the Internet 218. The PIMS 216 includes a PIMS server component 220, a user authentication proxy 222, and a PIMS dual-identity database 224.

In the illustrated setup, the user wants to add new device Aₙ 202 to the PDC 208. The device Aₙ 202 can be uniquely identified with UPIDₙ. The new device 202 can be added to the PDC 208 via its own PIMM UI 210. The user is prompted 228 for a username/password established with the PIMS 216 (or some other network service that utilizes PIMS 216 at the back end). The PIMM client 212 sends a request 230 to the PIMS 216 to add a device with UPIDₙ to the P2P identity of user A with credentials username/password “usr-A/password-A.” Paths 232-234 represent using the authentication proxy 222 via the PIMS server 220 to authenticate with a legacy server 235. The legacy server 235 may be unmodified, and the authentication 233, 234 may be performed in the standard way, using the credentials provided at 228.

In response to successful authentication 232-234, the PIMS adds 236 the UPIDₙ with the identity of user A in its dual identity database, as represented in table 238. As shown in row 238a, the user's Web identity (“usr-A”) with service 235 is associated with the UPID of all of the devices 202, 204, 206 of PDC 208. After the association of the UPID of device 206 in the dual identity database 224, the device 206 completes the process. The device 206 synchronizes 239-242 its local dual identity cache 214 with the entries 238a corresponding to user A and to his social contacts, if any.

All other PDC devices of user A (device A1 204, A2 206, . . . ), which are already in the PIMS dual identity database 224, synchronize 243-246 their respective local caches 250, 252, either after being notified by the PIMS or in their next periodic update. The synchronization of UPIDₙ with device 204 is represented by paths 243, 244, and the synchronization of UPIDₙ with device 206 is represented by paths 245, 246.

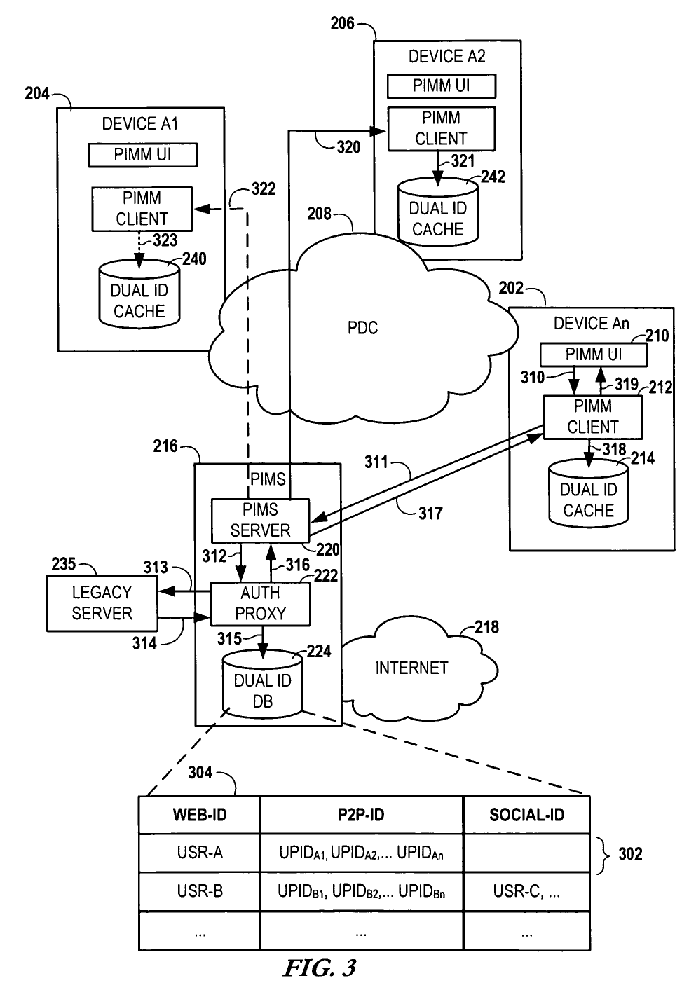

A similar process is followed when a user decides to remove one of his devices from his P2P identity. In FIG. 3, a block diagram illustrates a sequence of interactions for removing a device from a P2P identity according to an embodiment of the invention. In the scenario of FIG. 3, the user desires to remove device A1 204 from PDC 208. The user can use the device 204 itself, or any of his other devices (e.g. device Aₙ 202) to remove the UPID of device A1 204 from the P2P-ID pairing corresponding to “usr-A,” as shown by row 302 in updated table 304 of database 224.

In order to remove device 204, the user commands the removal 310 using the PIMM UI 210. A removal command 311 is communicated to the PIMS server 220, and includes authentication data for the service 235. The PIMS server 220 and authentication proxy 222 authenticate 312-314 with the legacy service 235, and the database 224 is updated 315 as indicated by table 304. The update is pushed out to devices 202 and 206 as indicated by paths 316-321. The device 204 to be removed may also be updated, as indicated by paths 316, 322, and 323.

The updates 322, 323 to the removed device 204 may be optional, because it may not be necessary to notify the device 204 that it was removed from the PDC 208 of user A. After the devices 202 and 206 have been updated 316-321, the devices 202, 206 will no longer accept authentication from UPID₁. This may be an advantage in some situations, such as where the device 204 is lost or is sent out for repairs. However, if the user is giving device 204 to somebody else, the updates 322, 323 may be desirable to the new owner of device 204 to prevent the device 204 from accepting authentication from other devices 202, 206 of the original user.

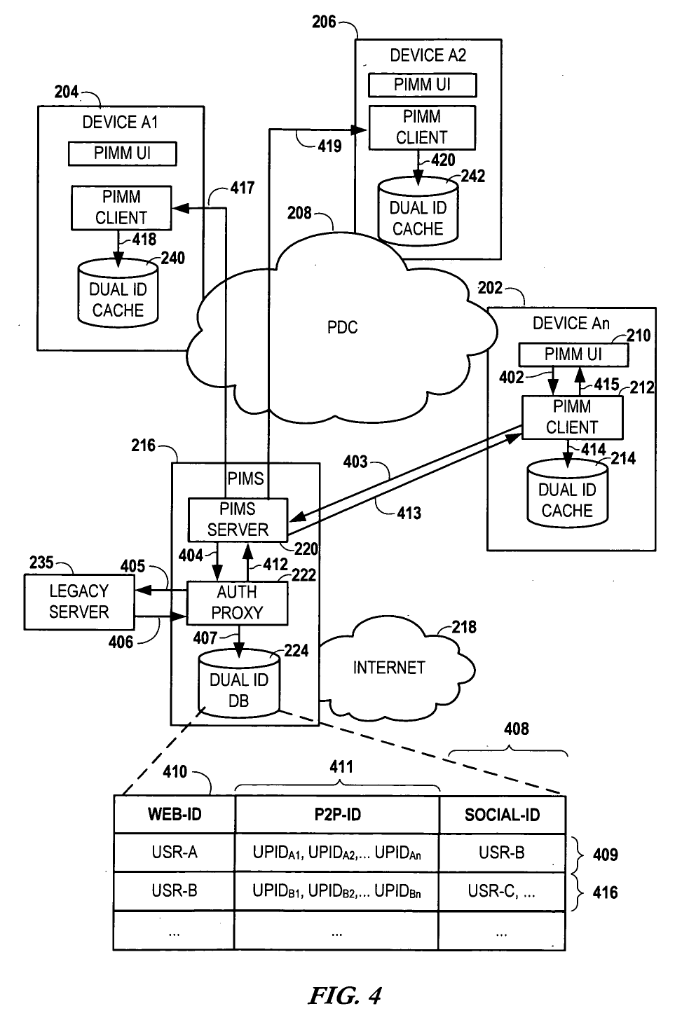

In reference now to FIG. 4, a block diagram illustrates a scenario for managing external user access permissions according to an embodiment of the invention. In this scenario, the user with identity “usr-A” wishes to add “usr-B” as a social contact. In this framework, the addition of a social contact may also provide the added user (in this case user B) certain permissions to access resources of the inviting user's PDC 208.

User A adds 402 user B as his social contact via the PIMM UI of any of the user's PDC devices (e.g., UI 210 of device 202), by specifying the username of user B that is associated with service 235 (e.g., “usr-B”). User A may also be prompted for his own username and/or password to service 235, although this may be optional (e.g., it may depend on user preferences) because the addition 402 of another user to the database 224 does not affect the identity of user A. However, the addition 402 may expose resources of PDC 208 to another user, so it may be desirable to ensure such an addition 402 is authorized.

The PIMM client sends a request 403 to the PIMS server 220 to add user “usr-B” as a social contact for user A with the service credentials username “usr-A” and (optionally) “password-A.” At optional steps 404-406, the PIMS user authentication proxy 222 authenticates with the legacy server 235 in the standard way, using the credentials provided at 402. If and when the user is authenticated 404-406, the PIMS adds 407 “usr-B” in the SOCIAL-ID field 408 of user A's entry 409 of table 410 stored in the dual identity database 224.

Alternatively, if authentication 404-406 is omitted, the PIMS server 220 may check to see if the requesting device with UPIDₙ is part of the P2P-ID 411 of user “usr-A.” If yes, the server 220 adds “usr-B” in the SOCIAL-ID field 408 of the “usr-A” entry 409 in the dual identity database 224. The second alternative may be less secure, because it only checks if a device belonging to user A is sending the request, not if a user who knows user A's password is making the request. However, assuming UPIDₙ is formed based on both hardware characteristics of device 202 and local authentication of user A on device 202 (if any), this alternative may be as secure as the local authentication used on device 202, if any.

Device 202 completes the process of adding user-B by synchronizing 412-415 the local dual identity cache 214 with the PIMS entries corresponding to “usr-A” 409 and “usr-B” 416. This may allow user B to access shared resources defined by user A for devices shown in P2P-ID field 411 of user A's entry 409. Note that the system may be configured to prevent transitive association of user B's own contacts with those of user A. For example, the SOCIAL-ID field 408 of user B's entry 416 contains a reference to “usr-C.” By default, the system may prevent user C from automatically gaining access to user A's shared resources. And even if such transitive association is configurably allowed, certain other steps may be required (e.g., explicit acceptance by user A) before such association is added to the database.

Because user B may wish to access shared resources of user A's PDC 208, the other PDC devices 204, 206 may synchronize 417-420 their respective local caches 240, 242 with the PIMS entries corresponding to users “usr-A” 409 and “usr-B” 416, either after being notified by the PIMS 216 or in their next periodic update. After these updates, devices 206, 206 will include entries in their local caches 240, 242 that authorize access for devices having a UUID shown in the P2P-ID field 411 of user B's entry 416 (e.g., UPID_{B1}, UPID_{B2}).

A similar process to that shown in FIG. 3 may be followed when a user decides to remove a user from his/her social contacts list. In such a case, the local caches 240, 242 would delete entries that authorize access for devices having a UUID shown in the P2P-ID field 411 of user B's entry 416. If the system does allow transitive association (e.g., access by user C based on adding user B), then the system may automatically (or in response to user input) delete the transitive association (e.g., delete permissions of user C when deleting permissions of user B) or leave any transitive association intact (e.g., retain permissions of user C when deleting permissions of user B).

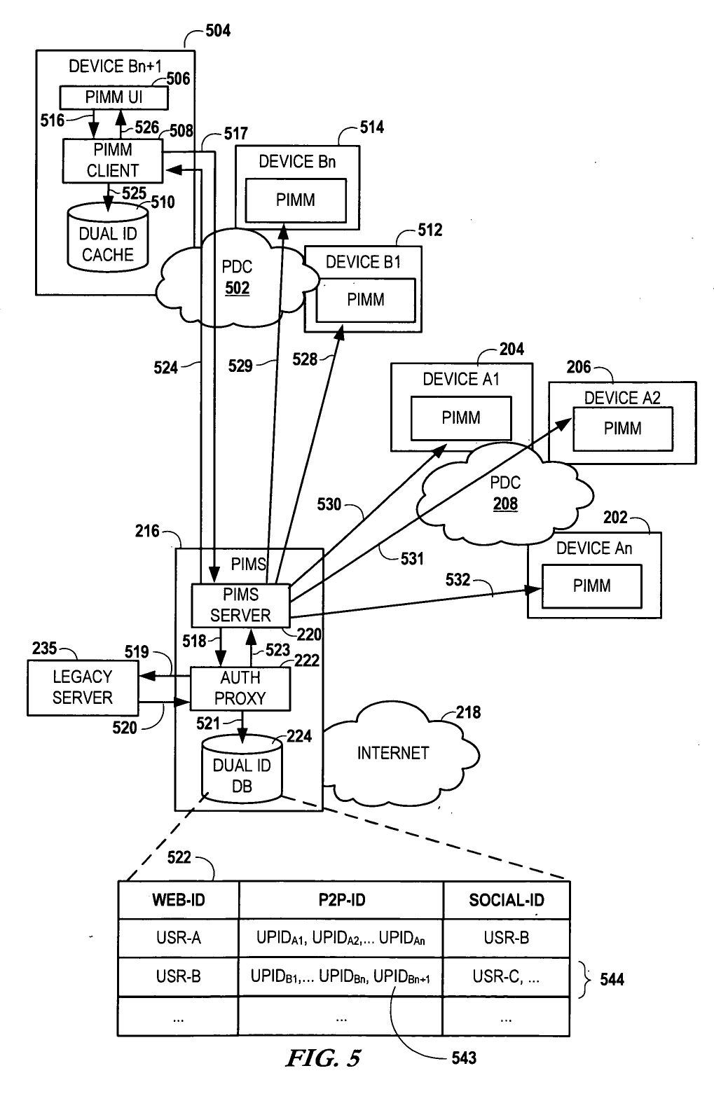

It will be appreciated that sharing resources between user PDCs will also require updating associations when a contact's PDC changes (e.g., add or remove device from a PDC). In reference now to FIG. 5, a block diagram illustrates a situation according to an embodiment of the invention where user B (who was added as shown in FIG. 4) adds (or removes) a device to his/her own PDC 502 after user A has added him as his social contact, thereby giving user B access to PDC 208.

User B wants to add a new device 504 (having PIMM UI 506, PIMM client 508, and dual identity cache 510) to his PDC 502 that also includes devices 512 and 514. The user is prompted 516 for a username/password associated with legacy service 235. The PIMM client 508 sends a request 517 to the PIMS server 220 to add a device with UPID_{Bn+1} to the P2P identity of user B with credentials username “usr-B/password-B” associated with legacy service 235. The PIMS user authentication proxy 222 authenticates 518-520 with the legacy server 235 (which is unmodified) in the standard way, using the provided credentials. The PIMS adds 521 UPID_{Bn+1} in the P2P identity of user B in its dual identity database 224, as seen by entry 543 in updated table 522.

Device 504 completes the process by synchronizing 523-526 its local dual identity cache with the updated entries corresponding to user B entries 544 in database 224. All other PDC devices 512, 514 user B, which are already in the PIMS dual identity database 224, synchronize 528, 529 their local caches, either after being notified by the PIMS or in their next periodic update. Further, all devices 202, 204, 206 of User A's PDC 208, which are already in the PIMS dual identity database 224, synchronize 530-532 their local caches, either after being notified by the PIMS 216 or in their next periodic update. This also holds true for any other user who has added user B as a social contact, e.g., a user whose PIMS dual identity database entry includes usr-B in the corresponding SOCIAL-ID field.

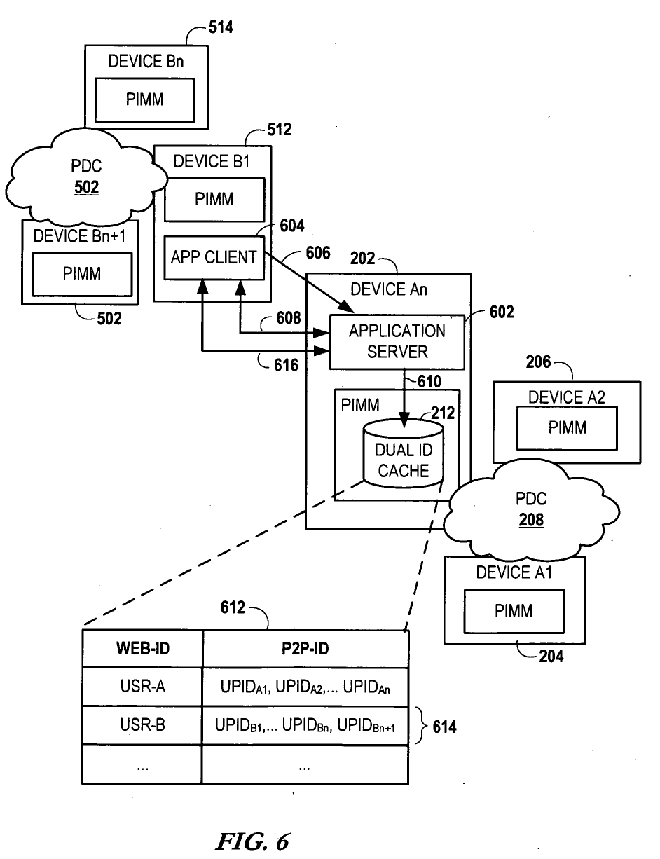

One aspect of the disclosed embodiments of the invention is that P2P interaction does not require access to the centralized identity management system or to the PIMS contemporaneously with the P2P interaction. An initial contact with the PIMS (and occasional updates) enables user devices to authenticate each other and control access to their resources based on the locally cached information of UPIDs. This process is described in greater detail in FIG. 6, which shows P2P interactions according to an embodiment of the invention.

As described in previous figures, User A has given User B access to a service (e.g., an application server 602) running on his device 202 (e.g., a Wi-Fi camera at home). This can happen for example though the use of Passlets or simply though setting the Access Control List (ACL) of the application server in device 202. User B uses an application client 604 of one of his devices 512 to access 606 the application server 602 of device 202. The application server 602 and/or security middleware (not shown) such as MyNetSec in device 202 authenticates 608 UPID_{B1} using the self-signed X.509 certificate provided by that device 512 (e.g., when establishing an SSL connection). A more complete description of MyNet-related security mechanisms (including Passlets and MyNetSec) is described in U.S. patent application Ser. No. 11/848,702 filed on Aug. 31, 2007 and entitled “Apparatus and Method for Managing Access to One or More Network Resources.” The application server 602 (or the security middleware) in device 202 looks 610 in its locally cached WEB-ID to P2P-ID cache 212 to see if UPID_{B1} corresponds to “usr-B,” e.g., as shown in entry 614 of table 612.

Assuming the cache 212 contains UPID_{B1} corresponding to “usr-B,” access to the application server 602 in device 202 is allowed and the results are returned 616 to the application client 604. Note that in this P2P interaction there is no need to authenticate the WEB-ID of user B (“usr-B”). In this way, there is no need for users' personal devices to locally store private security information (e.g., passwords for Web accounts) necessary to authenticate the WEB-ID. Therefore, this information is not compromised when the user loses a device or when a device is replaced.

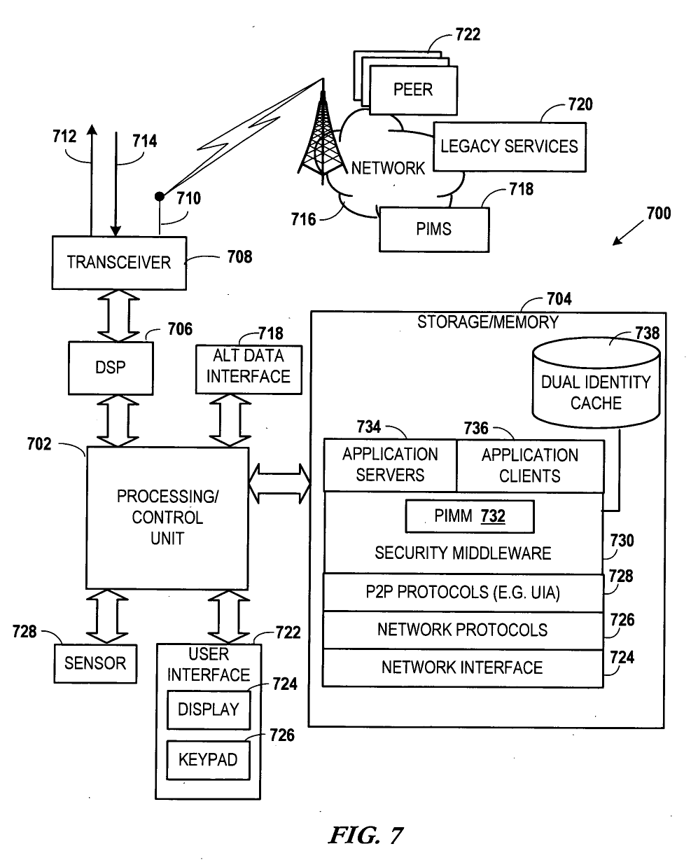

Many types of apparatuses may be able to participate in personal and social networks as described herein. Mobile devices are particularly useful in this role. In reference now to FIG. 7, an example is illustrated of a representative mobile computing arrangement 700 capable of carrying out operations in accordance with embodiments of the invention. Those skilled in the art will appreciate that the mobile computing arrangement 700 is merely representative of general functions that may be associated with such mobile devices, and also that landline user computing systems similarly include computing circuitry to perform such operations.

The processing unit 702 controls the basic functions of the arrangement 700. Those functions associated may be included as instructions stored in a program storage/memory 704. In one embodiment of the invention, the program modules associated with the storage/memory 704 are stored in non-volatile electrically-erasable, programmable read-only memory (EEPROM), flash read-only memory (ROM), hard-drive, etc. so that the information is not lost upon power down of the mobile terminal. The relevant software for carrying out conventional mobile terminal operations and operations in accordance with the present invention may also be transmitted to the mobile computing arrangement 700 via data signals, such as being downloaded electronically via one or more networks, such as the Internet and an intermediate wireless network(s).

The mobile computing arrangement 700 includes hardware and software components coupled to the processing/control unit 702 for performing network data exchanges. The mobile computing arrangement 700 may include multiple network interfaces for maintaining any combination of wired or wireless data connections. In particular, the illustrated mobile computing arrangement 700 includes wireless data transmission circuitry for performing network data exchanges.

This wireless circuitry includes a digital signal processor (DSP) 706 employed to perform a variety of functions, including analog-to-digital (A/D) conversion, digital-to-analog (D/A) conversion, speech coding/decoding, encryption/decryption, error detection and correction, bit stream translation, filtering, etc. One or more transceivers 708, generally coupled to one or more antennas 710, transmit the outgoing radio signals 712 and receive the incoming radio signals 714 associated with the wireless device.

The incoming and outgoing radio signals 712, 714 are used to communicate with a network 716. The network 716 may include any voice and data communications infrastructure known in the art, including CDMA, W-CDMA, GSM, EDGE, etc. The network 716 provides access to traditional landline data infrastructures, including IP networks such as the Internet. In particular, the network 716 hosts a PIMS 718 that provides authoritative linkages between globally unique user device identifiers and user identities associated with a legacy network service 720. The linkages allow the arrangement 700 to reliably authenticate with peer devices 722. The peer devices 722 may collectively form, with the arrangement 700, a PDC associated with a single user identity. In other situations, the peer devices 722 may be part of a PDC associated with a user identity of different user than that of arrangement 700, in which case the access permissions may be governed by rights granted to that other user by user of arrangement 700, and authenticated based on linkages formed and verified by PIMS 718.

The mobile computing arrangement 700 may also include an alternate network/data interface 718 capable of accessing the network 716 and/or a proximity network (not shown). The alternate data interface 718 may incorporate combinations of I/O and network standards such as USB, Bluetooth, Ethernet, 802.11 Wi-Fi, IRDA, Ultra Wide Band (UWB), Wimax, Wibree, etc.

The processor 702 is also coupled to user-interface elements 722 associated with the mobile terminal. The user-interface 722 of the mobile terminal may include, for example, a display 724 such as a liquid crystal display. Other user-interface mechanisms may be included in the interface 722, such as keypads 726, speakers, microphones, voice commands, switches, touch pad/screen, graphical user interface using a pointing device, trackball, joystick, etc. One or more sensors 728 may also be coupled to the processor 702 for purposes such as capturing content. These and other external interface components are coupled to the processor 702 as is known in the art.

The program storage/memory 704 includes operating systems and programs for carrying out functions and applications associated with functions on the mobile computing arrangement 700. The program storage 704 may include one or more of read-only memory (ROM), flash ROM, programmable and/or erasable ROM, random access memory (RAM), subscriber interface module (SIM), wireless interface module (WIM), smart card, hard drive, or other removable memory device. The storage/memory 704 of the mobile computing arrangement 700 may also include software modules for performing functions according to embodiments of the present invention.

In particular, the program storage/memory 704 may include any combination of resource sharing components as described in greater detail above. For example, a network interface 724 may be provided for accessing the network(s) 716. The network interface 724 may include a combination of hardware and software components, including media access circuitry, drivers, programs, and media access protocol modules. A networking protocol stack 726 may use common network protocols such as TCP/IP, UDP/IP, etc. At a higher level, one or more P2P protocol stacks 728 may facilitating P2P communications as described herein (e.g., ad-hoc connectivity, service discovery, service utilization).

The memory 704 may include a P2P security middleware 730 that provides P2P authentication services on behalf of device applications, such as application servers 734 and application clients 736. A PIMM 732 as describe herein may be included as part of the middleware 730, or may be separate from the middleware 730. The PIMM 732 may interact with the PIMS 718 to maintain a dual identity cache 738 that governs local P2P access to resources such as application servers 736. The PIMM 732 creates and updates the entries in the cache 738 based on occasional interaction with the PIMS 718, which can authoritatively authenticate user identities of peers 722 (as well as user of arrangement 700) with one or more legacy network services 720.

The PIMM 732 and/or middleware 730 may be able to authenticate access to resources by peers 722 without requiring contemporaneous access to PIMS 718 or legacy service 720. The PIMM 732 and/or middleware 730 may also be responsible for generating UPIDs associated with the arrangement and its users. The clients 736 may provide these UPIDs when attempting to access services of peers 722.

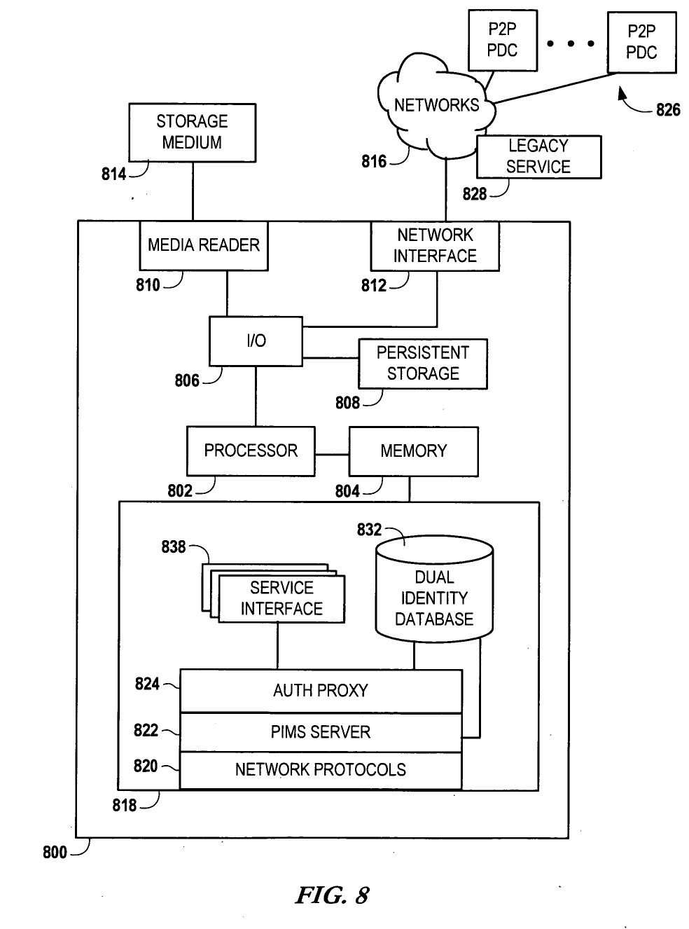

It will be appreciated that some of the adaptations above rely on various fixed infrastructure components to provide relatively infrequent authentication tasks. In reference now to FIG. 8, a block diagram illustrates an apparatus 800 that may perform any combination of infrastructure functions according to embodiments of the invention.

The apparatus 800 may include a processor 802, memory 804, and an I/O bus 806 that couples peripheral devices to the processor 802. Those peripheral devices may include persistent memory storage 808 (e.g., disc drives, flash memory), one or more network interfaces 812, and a media reader 810 (e.g., tape reader, floppy drive, Compact Disc player, Digital Versatile Disc player, memory card reader, etc.). The media reader 810 is capable of reading from a storage medium 814, such as optical or magnetic media. The media reader 810 may also be capable of writing to the media 814. The network interfaces 812 may be capable of communicating via one or more networks 816. The networks 816 may utilize such media such as phone lines, coaxial cable, Ethernet, wireless radio transmissions, infrared transmissions, etc. The networks 816 may include Internet Protocol (IP) based public and private networks.

The operation of the processor 802 is dictated by instructions 818 that may be stored temporarily or permanently in memory 804 or other logic circuitry. The instructions 818 may be built into to the apparatus 800 during manufacture, or may be later transferred to the apparatus 800 via the storage media 814 or the networks 816. The instructions 818 include one or common network protocol stacks 820 (e.g., TCP/IP, UDP/IP, etc.) that are used with the network interface 812 for accessing the network(s) 816. A PIMS server 822 and authentication proxy 824 may utilize the protocols stacks 820 for communicating with a plurality of personal device clusters 826. Each of the personal device clusters 826 includes one or more user devices that are bound to a single user identity. Those identities are associated with (and may be maintained by) one or more legacy services 828.

The authentication proxy 824 may include multiple service interfaces 830 that allow the proxy to authenticate users with a number of different legacy services 828 without requiring changes to those services 828. There may be a different interface 830 for various authentication schemes, including Web forms-based authentication, Kerberos, Remote Authentication Dial-In User Service (RADIUS), Secure Sockets Layer (SSL), SecurID, etc. The identities verified by authentication proxy 824 are coupled with globally unique identifiers of devices of the PDCs 826 and stored in a dual-identity database 832. The PIMS server 822 generally manages the database 832 via interactions with PDCs 826 on one side, and the authentication proxy 824 on the other.

The apparatus 800 may include other well-known features that are not illustrated, such as user input devices, user output devices, power circuitry, sensors, etc. As will be appreciated by one of skill in the art, an apparatus having the functions described herein may include a combination of two or more physical devices that are at least coupled via some data transfer medium to form a distributed computing arrangement. In other arrangements, the functions of various components represented by computing instructions 818 can be separated to operate via dependently or independently operating computing arrangements coupled by networks. For example, each function of PIMS server 822, authentication proxy 824 and dual-identity database 832 can each be separately implemented in physically dispersed apparatus that intercommunicate as described herein, but otherwise operate independently of each other.

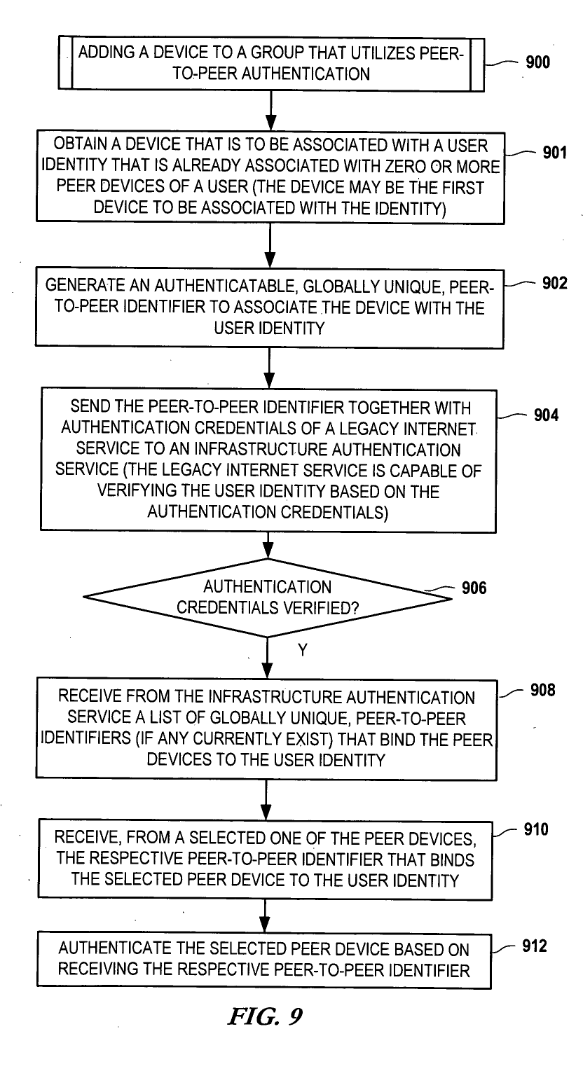

In reference now to FIG. 9, a flowchart illustrates a procedure 900 for adding a device to a group that uses peer-to-peer authentication according to an embodiment of the invention. The procedure involves obtaining 901 a device that is to be associated with a user identity that is already associated with zero or more peer devices of a user. The user identity may be used, for example, for defining permissions for sharing resources among the one or more peer devices. An authenticatable, globally unique, peer-to-peer identifier is generated 902 (e.g., by the new device itself) to associate the device with a user identity).

The peer-to-peer identifier, together with authentication credentials of a legacy Internet service, is sent 904 to an infrastructure authentication service. The legacy Internet service is capable of verifying the user identity based on the authentication credentials. Based on verification 906 of the authentication credentials, a list of globally unique, peer-to-peer identifiers that bind the peer devices to the user identity is received 908 from the infrastructure authentication service.

The identifiers that are received may be locally cached for further reference so that no access to the infrastructure authentication service is needed to authenticate the peer devices. Generally, when a selected peer device wishes to authenticate to the device, the device receives 910 from the selected peer device the respective peer-to-peer identifier that binds the selected peer device to the user identity. The device then authenticates 912 the selected peer device as associated with the user identity based on receiving the respective peer-to-peer identifier (e.g., by looking up the identifier in the local cache).

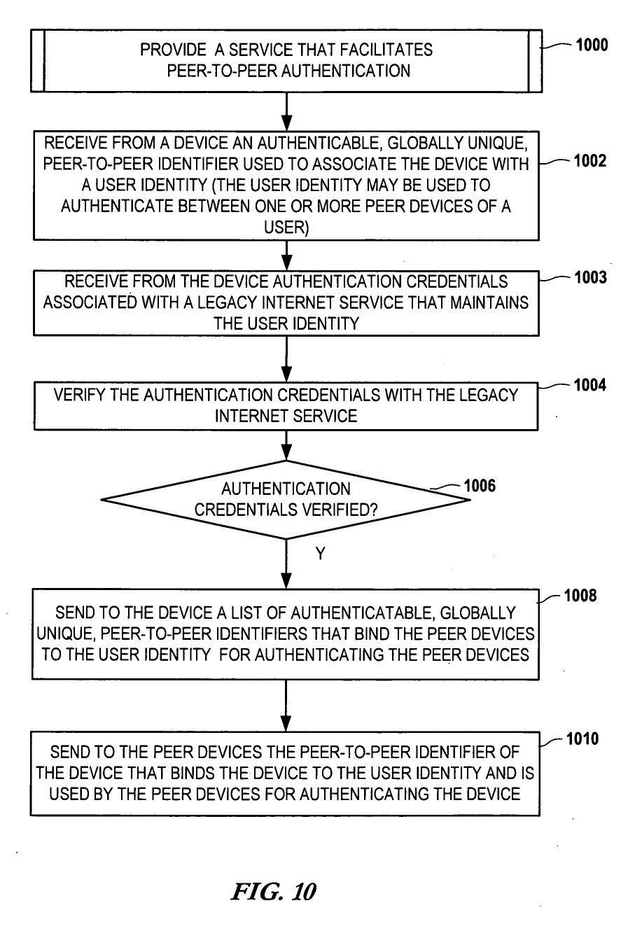

In reference now to FIG. 10, a flowchart illustrates a procedure 1000 for providing a service that facilitates peer-to-peer authentication according to an embodiment of the invention. The procedure 1000 involves receiving 1002 from a device an authenticatable, globally unique, peer-to-peer identifier used to associate the device with a user identity. The user identity may be used to authenticate between one or more peer devices of a user. Authentication credentials associated with a legacy Internet service that maintains the user identity are received 1003 from the device. The authentication credentials with the legacy Internet service are verified 1004.

Based on successful verification 1006 of the authentication credentials, a list of globally unique, peer-to-peer identifiers that bind the peer devices to the user identity for purposes of authenticating the peer devices are sent 1008 to the device. Also, the peer-to-peer identifier of the device that binds the device to the user identity is sent 1010 to the peer devices for purposes of authenticating the device.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A method comprising:
generating an authenticatable, globally unique, peer-to-peer identifier to associate a device with a user identity, wherein the user identity is associated with one or more peer devices of a user;
sending the peer-to-peer identifier together with authentication credentials of a legacy Internet service to an infrastructure authentication service, wherein the legacy Internet service is capable of verifying the user identity based on the authentication credentials;
based on verification of the authentication credentials, receiving from the infrastructure authentication service a list of authenticatable, globally unique, peer-to-peer identifiers that bind the peer devices to the user identity;
receiving, from a selected one of the peer devices, the respective peer-to-peer identifier that binds the selected peer device to the user identity; and
authenticating the selected peer device as associated with the user identity based on receiving the respective peer-to-peer identifier.

2. The method of claim 1, further comprising communicating the peer-to-peer identifier of the device to the peer devices to authenticate the device as associated with the user identity, wherein the peer-to-peer identity of the device is bound to the user identity via the infrastructure authentication service.

3. The method of claim 1, further comprising:
locally caching the list of peer-to-peer identifiers that bind the peer devices to the user identity; and
referencing the local cache when authenticating the selected peer device as associated with the user identity.

4. The method of claim 3, further comprising repeatedly comparing the local cache to a database of the infrastructure authentication service to determine a change in the list of peer-to-peer identifiers that bind the peer devices to the user identity.

5. The method of claim 1, further comprising:
determining a different user identity associated with the legacy Internet service;
sending, to the infrastructure authentication service, a request to authenticate other devices of the different user to the device and to the peer devices of the user;
receiving, from the infrastructure authentication service, a second list of authenticatable, globally unique, peer-to-peer identifiers that bind the other peer devices to the different user identity; and
authenticating the other peer devices as associated with the different user identity based on communication from the other peer devices of the respective peer-to-peer identifiers that bind the other peer devices to the different user identity.

6. The method of claim 5, wherein sending the request to authenticate other devices of the different user further comprises sending the authentication credentials of the user identity to verify the user identity before fulfilling the request.

7. The method of claim 1, further comprising regulating the selected peer device's access to resources of the device with permissions of the user based on authenticating the selected peer device.

8. A method comprising:
receiving from a device an authenticatable, globally unique, peer-to-peer identifier used to associate the device with a user identity, wherein the user identity may be used to share resources among one or more peer devices of a user;
receiving from the device authentication credentials associated with a legacy Internet service that maintains the user identity;
verifying the authentication credentials with the legacy Internet service; and
based on verification of the authentication credentials, a) sending to the device a list of authenticatable, globally unique, peer-to-peer identifiers that bind the peer devices to the user identity for authenticating the peer devices; and b) sending to the peer devices the peer-to-peer identifier of the device that binds the device to the user identity for authenticating the device.

9. The method of claim 8, further comprising repeatedly providing updates to the device in response to changes in the list of peer-to-peer identifiers that bind the peer devices to the user identity.

10. The method of claim 8, further comprising:
receiving from the device a request to authenticate other peer devices of a different user to a different user identity, wherein the different user identity is associated with the legacy Internet service;
determining a second list of authenticatable, globally unique, peer-to-peer identifiers that bind the other peer devices to the different user identity;
sending to the device the second list of peer-to-peer identifiers, wherein the device uses the second list of peer-to-peer identifiers to authenticate the other peer devices as associated with the different user.

11. The method of claim 10, wherein receiving the request to authenticate the other peer devices further comprises:
receiving from the device the authentication credentials associated with the legacy Internet service that maintains the user identity; and
verifying the authentication credentials with the legacy Internet services before fulfilling the request.

12. An apparatus comprising:
a network interface capable of Internet communications with a infrastructure authentication service and one more peer devices of a user;
a processor coupled to the network interface; and
memory coupled to the processor, the memory comprising instructions that cause the processor to:
generate an authenticatable, globally unique, peer-to-peer identifier to associate the apparatus with a user identity, wherein the user identity is associated with the one or more peer devices;
send the peer-to-peer identifier together with authentication credentials of a legacy Internet service to an infrastructure authentication service, wherein the legacy Internet service is capable of verifying the user identity based on the authentication credentials;
based on verification of the authentication credentials, receive from the infrastructure authentication service a list of authenticatable, globally unique, peer-to-peer identifiers that bind the peer devices to the user identity;
receive, from a selected one of the peer devices, the respective peer-to-peer identifier that binds the selected peer device to the user identity; and
authenticate the selected peer device as associated with the user identity based on receiving the respective peer-to-peer identifier.

13. The apparatus of claim 12, wherein the instructions further cause the processor to communicate the peer-to-peer identifier of the apparatus to the peer devices to authenticate the apparatus as associated with the user identity, wherein the peer-to-peer identity of the apparatus is bound to the user identity via the infrastructure authentication service.

14. The apparatus of claim 13, wherein the instructions further cause the processor to:
locally cache the list of peer-to-peer identifiers that bind the peer devices to the user identity; and
reference the local cache when authenticating the selected peer device.

15. The apparatus of claim 14, wherein the instructions further cause the processor to repeatedly compare the local cache to a database of the infrastructure authentication service to determine a change in the list of peer-to-peer identifiers that bind the peer devices to the user identity.

16. The apparatus of claim 12, wherein the instructions further cause the processor to:
determine a different user identity associated with the legacy Internet service;
send, to the infrastructure authentication service, a request to authenticate other devices of the different user to the apparatus and to the peer devices of the user;
receive, from the infrastructure authentication service, a second list of authenticatable, globally unique, peer-to-peer identifiers that bind other peer devices to the different user identity; and
authenticate the other peer devices as associated with the different user identity based on communication from the other peer devices of the respective peer-to-peer identifiers that bind the other peer devices to the different user identity.

17. The apparatus of claim 16, wherein sending the request to authenticate other devices of the different user further comprises sending the authentication credentials of the user identity to the legacy Internet service to verify the user identity before fulfilling the request.

18. The apparatus of claim 12, wherein the instructions further cause the processor to regulate the selected peer device's access to resources of the device with permissions of the user based on authenticating the selected peer device.

19. A computer readable storage medium having instructions stored thereon executable by a processor to:
generate an authenticatable, globally unique, peer-to-peer identifier to associate a device with a user identity, wherein the user identity is associated with one or more peer devices of a user;
send the peer-to-peer identifier together with authentication credentials of a legacy Internet service to an infrastructure authentication service, wherein the legacy Internet service is capable of verifying the user identity based on the authentication credentials;
based on verification of the authentication credentials, receive from the infrastructure authentication service a list of authenticatable, globally unique, peer-to-peer identifiers that bind the peer devices to the user identity;
receive, from a selected one of the peer devices, the respective peer-to-peer identifier that binds the selected peer device to the user identity; and
authenticate the selected peer device as associated with the user identity based on receiving the respective peer-to-peer identifier.

20. An apparatus comprising:
means for generating an authenticatable, globally unique, peer-to-peer identifier to associate the apparatus with a user identity, wherein the user identity is associated with one or more peer devices of a user;
means for sending the peer-to-peer identifier together with authentication credentials of a legacy Internet service to an infrastructure authentication service, wherein the legacy Internet service is capable of verifying the user identity based on the authentication credentials;
means for receiving from the infrastructure authentication service a list of authenticatable, globally unique, peer-to-peer identifiers that bind the peer devices to the user identity based on verification of the authentication credential;
means for receiving, from a selected one of the peer devices, the respective peer-to-peer identifier that binds the selected peer device to the user identity; and
means for authenticating the selected peer device as associated with the user identity based on receiving the respective peer-to-peer identifier.

21. The apparatus of claim 20, further comprising:
means for locally caching the list of peer-to-peer identifiers that bind the peer devices to the user identity; and
means for referencing the local cache when authenticating the selected peer device as associated with the user identity.

22. The apparatus of claim 20, further comprising:
means for determining a different user identity associated with the legacy Internet service;
means for sending, to the infrastructure authentication service, a request to authenticate other devices of the different user to the device and to the peer devices of the user;
means for receiving, from the infrastructure authentication service, a second list of authenticatable, globally unique, peer-to-peer identifiers that bind other peer devices to the different user identity; and
means for authenticating the other peer devices as associated with the different user identity based on communication from the other peer devices of the respective peer-to-peer identifiers that bind the other peer devices to the different user identity.

23. The apparatus of claim 20, further comprising means for regulating the selected peer device's access to resources of the device with permissions of the user based on authenticating the selected peer device.
